(19) United States
(12) Patent Application Publication
(10) Pub. No.: US 2014/0146275 A1
(43) Pub. Date: May 29, 2014

(54) Reactive Monomer of Liquid Crystal on Polyimide Surface of Alignment Film and Liquid Crystal Panel

(71) Applicants: Chung-Ching Hsieh, Shenzhen (CN); Chengming He, Shenzhen (CN)

(72) Inventors: Chung-Ching Hsieh, Shenzhen (CN); Chengming He, Shenzhen (CN)

(73) Assignee: Shenzhen China Star Optoelectronics Technology Co., Ltd., Guangming (CN)

(21) Appl. No.: 13/259,281

(22) PCT Filed: Aug. 15, 2011
(86) PCT No.: PCT/CN2011/078398

§ 371 Date: Sep. 23, 2011

(30) Foreign Application Priority Data
Aug. 4, 2011 (CN) 201110222463.9

(51) Int. Cl. G02F 1/1333

(52) U.S. Cl. CPC G02F 1/133365
USPC 349/86; 428/1.26

(57) ABSTRACT

The present invention provides a reactive monomer of liquid crystal on a polyimide surface of an alignment film and a liquid crystal panel. The molecular weight of the reactive monomer of liquid crystal is ranged between 322 and 500, and the UV wavelength for polymerizing and curing the reactive monomer of liquid crystal and the polyimide surface is greater than or equal to 300 nm. The reactive monomer of liquid crystal can lower the interaction between the reactive monomer of liquid crystal and the PI surface of the alignment film, so as to improve the phenomenon of drop Mura defect occurred during implementing the ODF technology. Meanwhile, because the curing speed of polymerization and curing reaction is relatively raised, it can also carry out a purpose of energy saving and carbon reduction.

### FIELD OF THE INVENTION

The present invention relates to a reactive monomer of liquid crystal and a liquid crystal panel, and more particularly to a reactive monomer of liquid crystal on a polyimide surface of an alignment film and a liquid crystal panel having the reactive monomer of liquid crystal.

### BACKGROUND OF THE INVENTION

Traditionally, the injection method of liquid crystal during manufacturing a liquid crystal panel is to slowly inject liquid crystal into a space between two combined glass substrates according to the capillarity principle, but the disadvantage is that the method consumes much time and waste material of liquid crystal

The foregoing injection method of liquid crystal is gradually replaced by a one-drop filling (ODF) technology. In the one-drop filling technology, liquid crystal is firstly and directly dropped onto a glass substrate through a liquid crystal dropping device, and then the glass substrate is aligned and combined with the other glass substrate. This new technology can substantially save filling time of liquid crystal and material of liquid crystal.

However, when manufacturing some liquid crystal panel having liquid crystal alignment capable of improving visual angles, the liquid crystal is dropped onto an alignment film of a substrate by the one-drop filling technology, wherein the alignment film is impacted by the drops of liquid crystal to thus cause the phenomenon of drop Mura defect occurred on a finished product.

If reactive monomers (RMs) of liquid crystal are added, the reactive monomers can cause that liquid crystal molecules of a liquid crystal composition dropped within liquid crystal cells has a predetermined inclined angle in relation to an polyimide (PI) surface of the alignment film, in order to help the alignment of the liquid crystal molecules and be used as an application of liquid crystal display (LCD) device. However, the interaction between the traditional reactive monomers of liquid crystal and the traditional PI surface of the alignment film is excess, resulting in occurring serious phenomenon of drop Mura defect on the liquid crystal panel.

For more details, referring now to FIG. 1A, a schematic view of a traditional one-drop filling (ODF) technology dropping a liquid crystal composition onto an alignment film of a transparent substrate is illustrated. Referring to FIGS. 1B and 1C, schematic views of reactive monomers 1 of liquid crystal in the liquid crystal composition deposited on a polyimide surface 2 of the alignment film are illustrated, wherein the phenomenon of drop Mura defect is caused because different amounts of the reactive monomers 1 of liquid crystal are unevenly deposited on the polyimide surface 2 of the alignment film on the transparent substrate.

The reactive monomers 1 of liquid crystal used by the traditional ODF technology have the following molecular formula (I) and the molecular weight thereof is lower than 300.

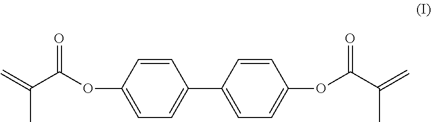 [SMILES: C=C(C)C(=O)Oc1ccc(-c2ccc(OC(=O)C(=C)C)cc2)cc1]

When changing the cell gap of the liquid crystal to be smaller than 3.8 μm, it causes that the traditional reactive monomers 1 of liquid crystal can not be widely dispersed on a large area of the polyimide surface 2 of the alignment film, and thus different amounts of the reactive monomers 1 of liquid crystal are unevenly deposited on the polyimide surface 2 of the alignment film, as shown in FIGS. 1B and 1C. Thus, when the cell gap of the liquid crystal is smaller than 3.8 μm, there will be the phenomenon of drop Mura defect on the liquid crystal panel.

For more details, the reason causing the phenomenon of drop Mura defect is that the interaction between the traditional reactive monomers 1 of liquid crystal and the traditional PI surface 2 of the alignment film is excess, and thus it is disadvantageous to evenly deposit the liquid crystal composition containing the reactive monomers 1 of liquid crystal onto the polyimide surface 2 of the alignment film.

As a result, it is necessary to provide a new reactive monomer of liquid crystal to solve the problems existing in the conventional technologies, as described above.

### SUMMARY OF THE INVENTION

A primary object of the present invention is to provide a reactive monomer of liquid crystal, which has a suitable interaction between a polyimide (PI) surface of an alignment film, so as to avoid from occurring the phenomenon of drop Mura defect.

To achieve the above object, the present invention provides a reactive monomer of liquid crystal on a polyimide surface of an alignment film, wherein the reactive monomer of liquid crystal is contained in a liquid crystal composition, so that liquid crystal molecules in the liquid crystal composition has a predetermined inclined angle in relation to the polyimide surface of the alignment film, characterized in that: the molecular weight of the reactive monomer of liquid crystal is ranged between 322 and 500, the ultraviolet (UV) wavelength for polymerizing and curing the reactive monomer of liquid crystal and the polyimide surface is greater than or equal to 300 nm; wherein the liquid crystal composition is a liquid crystal composition of a one-drop filling (ODF) technology, and the polyimide surface of the alignment film is formed on a transparent substrate.

In one embodiment of the present invention, the transparent substrate is a glass substrate.

In one embodiment of the present invention, the transparent substrate is a flexible polymer substrate or an inflexible polymer substrate.

To achieve the above object, the present invention further provides a reactive monomer of liquid crystal on a polyimide surface of an alignment film, wherein the reactive monomer of liquid crystal is contained in a liquid crystal composition, so that liquid crystal molecules in the liquid crystal composition has a predetermined inclined angle in relation to the polyimide surface of the alignment film, the molecular weight of the reactive monomer of liquid crystal is ranged between 322 and 500, an ultraviolet (UV) spectrum of the reactive monomer of liquid crystal has a characteristic absorption peak at a wavelength greater than or equal to 300 nm.

In one embodiment of the present invention, the liquid crystal composition is a liquid crystal composition of a one-drop filling (ODF) technology.

A secondary object of the present invention is to provide a liquid crystal panel which has a transparent substrate and an alignment film, and a polyimide (PI) surface of an alignment film is dispersed with a liquid crystal composition, wherein the liquid crystal composition contains at least one type of reactive monomer of liquid crystal, the reactive monomer of liquid crystal causes liquid crystal molecules in the liquid crystal composition of a liquid crystal cell to have a predetermined inclined angle in relation to the polyimide surface of the alignment film for helping the alignment of liquid crystal molecules. Furthermore, the molecular weight of the reactive monomer of liquid crystal is ranged between 322 and 500, and the ultraviolet (UV) wavelength for polymerizing and curing the reactive monomer of liquid crystal and the polyimide surface is greater than or equal to 300 nm.

In one embodiment of the present invention, the liquid crystal composition is a liquid crystal composition of a one-drop filling (ODF) technology.

In one embodiment of the present invention, the transparent substrate is a glass substrate.

In one embodiment of the present invention, the transparent substrate is a flexible polymer substrate or an inflexible polymer substrate.

The positive effect of the present invention is that: the reactive monomer of liquid crystal can lower the interaction between the reactive monomer of liquid crystal and the PI surface of the alignment film on the transparent substrate, so as to improve the phenomenon of drop Mura defect occurred during implementing the ODF technology. Meanwhile, because the curing speed of polymerization and curing reaction of the reactive monomer of liquid crystal and the polyimide surface is relatively raised, it can also carry out a purpose of energy saving and carbon reduction.

### DESCRIPTION OF THE DRAWINGS

FIG. 1A is a schematic view of a traditional one-drop filling (ODF) technology dropping a liquid crystal composition onto an alignment film of a transparent substrate;

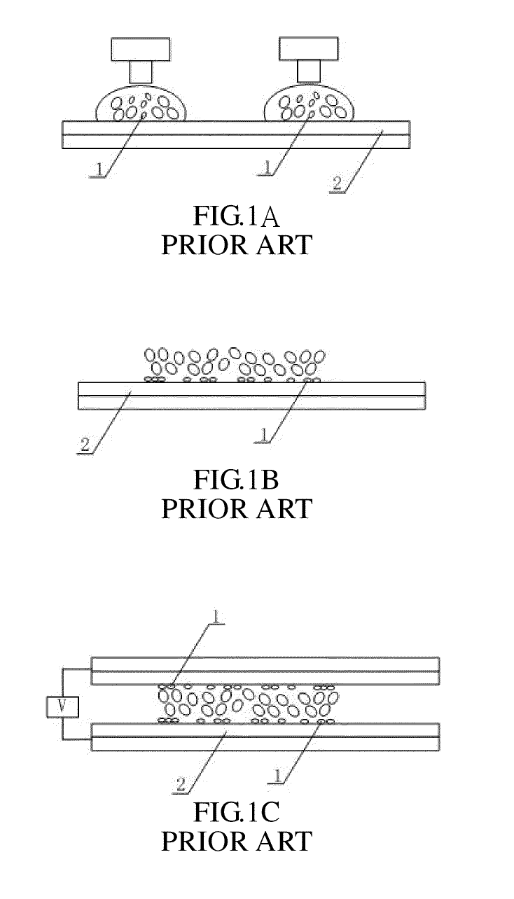

FIGS. 1B and 1C are schematic views of reactive monomers of liquid crystal in the liquid crystal composition deposited on a polyimide surface of the alignment film; and

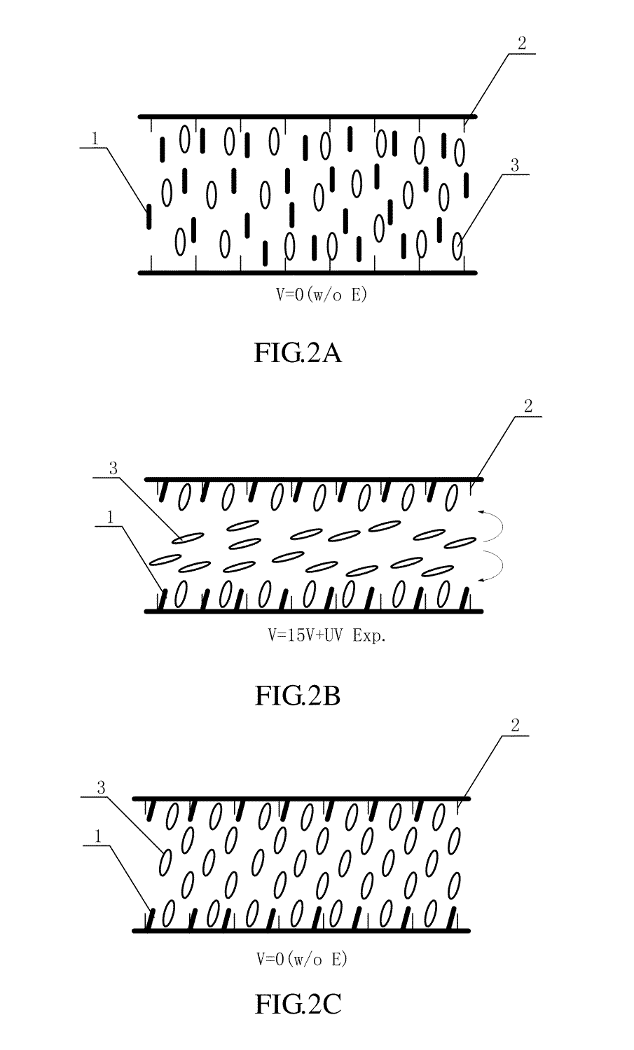

FIGS. 2A to 2D are schematic views of a one-drop filling (ODF) technology dropping a liquid crystal composition of the present invention onto an alignment film of a transparent substrate according to a preferred embodiment of the present invention;

Wherein

The numeral 1 represents reactive monomers of liquid crystal;

The numeral 2 represents polyimide (PI) surface; and

The numeral 3 represents liquid crystal molecules.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings.

According to a preferred embodiment of the present invention, the present invention provides a reactive monomer (RM) of liquid crystal, wherein the reactive monomer of liquid crystal is contained in a liquid crystal composition, so that liquid crystal molecules in the liquid crystal composition can have a predetermined inclined angle, the molecular weight of the reactive monomer of liquid crystal is ranged between 322 and 500, and the ultraviolet (UV) wavelength for polymerizing and curing the reactive monomer of liquid crystal and the polyimide surface is greater than or equal to 300 nm.

In the present invention, the liquid crystal composition is preferably a liquid crystal composition of a one-drop filling (ODF) technology, which is used to cause the liquid crystal composition to have the predetermined inclined angle.

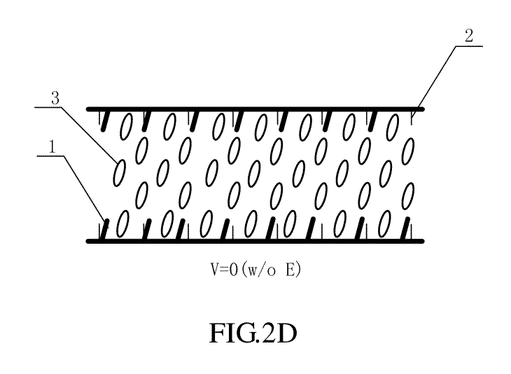

For more details, referring now to FIGS. 2A to 2D, schematic views of a one-drop filling (ODF) technology dropping a liquid crystal composition of the present invention onto an alignment film of a transparent substrate according to a preferred embodiment of the present invention are illustrated, wherein opposite surfaces of two transparent substrates are pre-coated with polyimide to form a polyimide (PI) surface 2 used as an alignment film, respectively. The ODF technology is used to add the liquid crystal composition containing a reactive monomer (RM) 1 of liquid crystal into a space between the two transparent substrates, to apply voltage onto opposite transparent electrode layers of the two transparent substrates, and then to cure by ultraviolet (UV). Thus, liquid crystal molecules 3 in the liquid crystal composition can have a predetermined inclined angle in relation to the polyimide surface 2 of the alignment film. The molecular structure of the reactive monomer 1 of liquid crystal can be selected from the reactive monomer of liquid crystal having the foregoing molecular formula (I) or derivatives and analogues thereof.

Referring now to Tab. 1, observed results of the phenomenon of drop Mura defect for different types of reactive monomers 1 of liquid crystal of the present invention (RM1-4) under the same PI condition of the alignment film are shown in Tab. 1. Apparently, as shown in Tab. 1, the reactive monomers 1 of liquid crystal of the present invention (RM1-4) can overcome the defect of the traditional reactive monomers of liquid crystal and thus can improve the phenomenon of drop Mura defect. Moreover, for the polymerization and curing reaction of the reactive monomer (RM2 and 4) of liquid crystal and the polyimide (PI) surface 2, the curing speed thereof is apparently raised, and the purpose of energy saving and carbon reduction can be carried out.

TABLE 1

| | | | | UV wavelength | |
|---|---|---|---|---|---|
| | | | | range for | |
| | | | | polymerizing | phenomenon |
| | Molecular | Retention Time of | | and curing with | of drop |
| RM | Weight | HPLC | Curing Time | PI | Mura defect |
| Original RM | 322 | 2.79 min | Curing time of | ~300 nm | Extremely |
| | | | original RM | | few |
| RM1 | 340 | 2.79 min | constant | ~300 nm | Extremely |
| | | | | | few |
| RM2 | 346 | 3.23 min | become 1/4 | >300 nm | Few |
| RM3 | 402 | 6.33 min | constant | ~300 nm | Few |
| RM4 | 422 | 3.23 min | become 1/7 | ~300 nm | Few |

For more details, the present invention firstly applies voltage onto opposite transparent electrode layers of the two transparent substrates, and then applies UV light to carry out a polymerization and curing reaction of the reactive monomer (RM) 1 of liquid crystal and the polyimide (PI) surface 2, so that liquid crystal molecules 3 in the liquid crystal composition has a predetermined inclined angle in relation to the polyimide surface 2 of the alignment film. The reactive monomer (RM1-4) of liquid crystal can lower the interaction between the reactive monomer of liquid crystal and the PI surface of the alignment film, so as to improve the phenomenon of drop Mura defect occurred during implementing the ODF technology. Meanwhile, because the curing speed of polymerization and curing reaction is relatively raised, it can also carry out a purpose of energy saving and carbon reduction.

The present invention has been described with a preferred embodiment thereof and it is understood that many changes and modifications to the described embodiment can be carried out without departing from the scope and the spirit of the invention that is intended to be limited only by the appended claims.

1. A reactive monomer of liquid crystal on a polyimide surface of an alignment film, the reactive monomer of liquid crystal is contained in a liquid crystal composition, so that liquid crystal molecules in the liquid crystal composition has a predetermined inclined angle in relation to the polyimide surface of the alignment film, characterized in that: the molecular weight of the reactive monomer of liquid crystal is ranged between 322 and 500, the UV wavelength for polymerizing and curing the reactive monomer of liquid crystal and the polyimide surface is greater than or equal to 300 nm; wherein the liquid crystal composition is a liquid crystal composition of a one-drop filling technology, and the polyimide surface of the alignment film is formed on a transparent substrate.

2. The reactive monomer of liquid crystal according to claim 1, characterized in that: the transparent substrate is a glass substrate.

3. The reactive monomer of liquid crystal according to claim 1, characterized in that: the transparent substrate is a flexible polymer substrate or an inflexible polymer substrate.

4. A reactive monomer of liquid crystal on a polyimide surface of an alignment film, the reactive monomer of liquid crystal is contained in a liquid crystal composition, so that liquid crystal molecules in the liquid crystal composition has a predetermined inclined angle in relation to the polyimide surface of the alignment film, characterized in that: the molecular weight of the reactive monomer of liquid crystal is ranged between 322 and 500, and the UV wavelength for polymerizing and curing the reactive monomer of liquid crystal and the polyimide surface is greater than or equal to 300 nm.

5. The reactive monomer of liquid crystal according to claim 4, characterized in that: the liquid crystal composition is a liquid crystal composition of a one-drop filling technology.

6. The reactive monomer of liquid crystal according to claim 4, characterized in that: the polyimide surface of the alignment film is formed on a transparent substrate.

7. The reactive monomer of liquid crystal according to claim 6, characterized in that: the transparent substrate is a glass substrate.

8. The reactive monomer of liquid crystal according to claim 6, characterized in that: the transparent substrate is a flexible polymer substrate or an inflexible polymer substrate.

9. A liquid crystal panel, having a transparent substrate and an alignment film, characterized in that: a polyimide surface of an alignment film is dispersed with a liquid crystal composition, wherein the liquid crystal composition contains at least one type of reactive monomer of liquid crystal, the reactive monomer of liquid crystal causes liquid crystal molecules in the liquid crystal composition to have a predetermined inclined angle in relation to the polyimide surface of the alignment film, the molecular weight of the reactive monomer of liquid crystal is ranged between 322 and 500, and the UV wavelength for polymerizing and curing the reactive monomer of liquid crystal and the polyimide surface is greater than or equal to 300 nm.

10. The liquid crystal panel according to claim 9, characterized in that: the liquid crystal composition is a liquid crystal composition of a one-drop filling technology.

11. The liquid crystal panel according to claim 9, characterized in that: the transparent substrate is a glass substrate.

12. The liquid crystal panel according to claim 9, characterized in that: the transparent substrate is a flexible polymer substrate or an inflexible polymer substrate.
